(19) United States
(12) Patent Application Publication
(10) Pub. No.: US 2025/0116793 A1
(43) Pub. Date: Apr. 10, 2025

(54) NMR INTERPRETATION USING A RADIAL RESPONSE FUNCTION

(71) Applicant: Schlumberger Technology Corporation, Sugar Land, TX (US)

(72) Inventors: Ahmed Fathi Mahmoud Allam, Dammam (SA); David Furse Allen, Katy, TX (US); Zeyad Ramadan, Katy, TX (US)

(21) Appl. No.: 18/907,136

(22) Filed: Oct. 4, 2024

Related U.S. Application Data
(60) Provisional application No. 63/588,415, filed on Oct. 6, 2023.

(51) Int. Cl. G01V 3/32; G01V 3/34

(52) U.S. Cl. CPC G01V 3/32; G01V 3/34

(57) ABSTRACT

A method for interpreting nuclear magnetic resonance (NMR) logging measurements includes acquiring NMR logging measurements in a horizontal or near horizontal wellbore. A radial response function for the NMR logging tool is acquired and used in combination with the acquired NMR logging measurements to interpret a subterranean formation model including at least two layers. The radial response function may be estimated by computing contribution coefficients from a first derivative of NMR measurements made at a plurality of fluid levels in a fluid tank.

### CROSS REFERENCE TO RELATED APPLICATIONS

This application claims priority to U.S. Provisional Patent Application No. 63/588,415, which was filed on Oct. 6, 2023 and is incorporated herein by reference in its entirety.

### BACKGROUND

Nuclear Magnetic Resonance (NMR) measurements are commonly made while drilling or logging and are commonly used to measure properties of earth formations, such as the fractional volume of pore space, the fractional volume of mobile fluid filling the pore space, and the porosity of earth formations. NMR measurements may also be used to assess the content of brine and hydrocarbons in the formation. The signals measured by NMR logging tools arise from selected nuclei in the probed volume. Since hydrogen nuclei are the most abundant and easily detectable, most NMR logging tools are tuned to detect hydrogen resonance signals (from either water or hydrocarbons).

While the use of NMR measurements is common, their interpretation is challenging. For example, the measurements are sensitive to a number of factors including, the diffusion rate and tumbling/rotation rate of hydrogen atoms in different molecules as well as the structure and substructure (e.g., the porosity) of the formation bedding close to the wellbore. There is a need in the industry for improved methods for interpreting NMR measurements, particularly interpreting thin bed NMR responses in horizontal or near horizontal wellbores.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling system incorporating a disclosed NMR logging system.

FIG. 2 depicts one example NMR pulse sequence for making NMR measurements.

FIG. 3 depicts another example NMR pulse sequence for making NMR measurements.

FIG. 4 depicts a portion of an example NMR signal obtained using the pulse sequence of FIG. 3.

FIGS. 5A and 5B (collectively FIG. 5) depict an example NMR tool and a corresponding sensitive region in a wellbore.

FIG. 6 depicts an axial cross section of the example NMR tool shown in FIG. 5 penetrating a formation having alternating thin beds.

FIGS. 7A and 7B (collectively FIG. 7) depict flow charts of example methods of interpreting a formation model using NMR measurements.

FIG. 8 depicts flow chart of a method for measuring a radial response function of an NMR logging tool.

FIG. 9 depicts an axial cross section of the NMR tool shown in FIG. 5 deployed in a fluid tank.

FIGS. 10A and 10B (collectively FIG. 10) depict plots of NMR tool response (10A) and contribution coefficients computed from the first derivative thereof (10B) for the experiment shown on FIG. 9.

FIGS. 11A and 11B (collectively FIG. 11) depict the contribution coefficients for each water level computed from a discrete derivative of the measured NMR responses (11A) and a continuous response function (11B) for the experiment shown on FIG. 9.

FIGS. 12A, 12B, 12C, and 12D (collectively FIG. 12) depict an example interpretation in which an NMR logging tool crosses a dipping thin bed during a logging operation.

### DETAILED DESCRIPTION

Methods and systems for interpreting nuclear magnetic resonance (NMR) logging measurements are disclosed. In one example embodiment a method comprises acquiring NMR logging measurements made with an NMR logging tool deployed in a horizontal or near horizontal wellbore. A radial response function for the NMR logging tool is acquired and used in combination with the acquired NMR logging measurements to interpret a subterranean formation model including at least two layers.

In another embodiment, a method for estimating a radial response function of a nuclear magnetic resonance (NMR) logging tool includes deploying an NMR logging tool horizontally in a fluid tank and using the deployed NMR logging tool to make NMR measurements at each of a plurality of fluid levels in the fluid tank to obtain corresponding NMR responses. Contribution coefficients are computed from a first derivative of the NMR responses with respect to a distance from an axis of the NMR logging tool to obtain the radial response function.

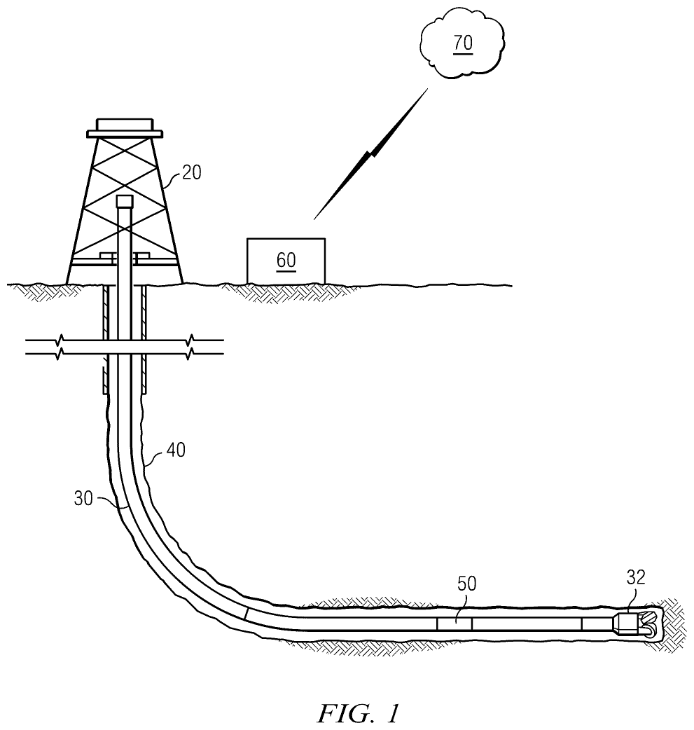

FIG. 1 depicts a schematic drilling rig 20 including a drill string 30 and an NMR logging tool 50 deployed in the string and disposed within a wellbore 40. The drilling rig 20 may be deployed in either onshore or offshore applications (an onshore application is depicted). In this type of system, the wellbore 40 may be formed in subsurface formations by rotary drilling in a manner that is well-known to those of ordinary skill in the art (e.g., via well-known directional drilling techniques).

As is known to those of ordinary skill, the drill string 30 may be rotated, for example, at the surface to drill the well (e.g., via a rotary table). A pump may deliver drilling fluid to the interior of the drill string 30 thereby causing the drilling fluid to flow downwardly through the drill string 30. The drilling fluid exits the drill string 30, e.g., via ports in a drill bit 32, and then circulates upwardly through the annulus region between the outside of the drill string 30 and the wall of the wellbore 40. In this known manner, the drilling fluid lubricates the drill bit 32 and carries formation cuttings up to the surface.

In the illustrated embodiment, the NMR logging tool 50 may be deployed in a bottom hole assembly (BHA) including, for example, a rotary steerable system (RSS), a motor, drill bit 32, a measurement while drilling (MWD) tool, and/or one or more other logging-while-drilling (LWD) tools (none of which are shown). The LWD tools may be configured to measure one or more properties of the formation through which the wellbore penetrates, for example, including resistivity, density, porosity, sonic velocity, gamma ray counts, and the like. The MWD tool may be configured to measure one or more properties of the wellbore 40 as the wellbore as it is drilled or at any time thereafter. The physical properties may include pressure, temperature, wellbore caliper, wellbore trajectory (attitude), and the like. The disclosed embodiments are, of course, no limited to any particular BHA configuration or even to LWD operations. The disclosed embodiments are equally well suited for wireline logging operations.

With further reference to FIG. 1, drilling rig 20 may further include an onsite operations or oilfield evaluation facility 60 (e.g., a control room or a field office) which may be in communication with an offsite operations center 70 (the cloud). In the depicted embodiment, the onsite 60 and/or offsite 70 facilities may include a system for evaluating NMR measurements including a computer or computer system. The communication may be hardwired and/or wireless (e.g., internet connectivity) and may enable NMR logging data to be transmitted from the onsite facility 60 to the offsite facility 70. The computer system may include one or more processors (e.g., microprocessors) which may be connected to one or more data storage devices (e.g., hard drives or solid-state memory) and user interfaces as well as to cloud based storage or additional processors. It will be further understood that the disclosed embodiments may include processor executable instructions stored in the data storage device. The executable instructions may be configured, for example, to execute methods 100, 120, and 150 for interpreting NMR measurements and/or estimating the radial response function of an NMR tool. It will of course be understood that the disclosed embodiments are not limited to the use of any particular computer hardware and/or software.

With continued reference to FIG. 1, the NMR logging tool 50 may include a detection coil (commonly referred to as an antenna) that may measure the properties of nuclear spins in the formation, such as the longitudinal (or spin-lattice) relaxation time T1, transverse (or spin-spin) relaxation time T2, and a diffusion coefficient D. Knowledge of these NMR properties may help aid in the determination of basic formation properties such as permeability and porosity, as well as the fluid properties such as fluid type and viscosity. Multi-dimensional NMR techniques, for example, that measure distributions of two or more of T1, T2, and/or D may provide quantitative fractions of different fluids (e.g., oil, water, gas) and a better understanding of the diffusion properties of these fluids in the surrounding formation, including the effects of geometry and restricted diffusion.

As is known to those of ordinary skill in the art, NMR well logging includes generating a static magnetic field (the B₀ field) within a wellbore (e.g., under the earth's surface), applying a series of radio frequency (RF) electromagnetic pulses to the volume around the wellbore (the B₁ field), measuring signals (echoes) received in response to the RF pulses, and evaluating the received echoes to determine characteristics of the interrogation volume in proximity to the wellbore. The measured NMR characteristics commonly include T1, T2, and/or D distributions as described above. In addition to these one-dimensional (1D) measurements of relaxation times and diffusion coefficients, NMR logs may also provide two-dimensional (2D) maps showing the relationship between diffusion and relaxation times (e.g., D-T1 or D-T2 maps) and the relationship between longitudinal and transverse relaxation times (e.g., T1-T2 maps). These maps may be used to determine formation properties, such as porosity and permeability, as well as fluid properties such as the saturation of oil, water and gas. These 2D maps often enable water, gas, and oil signals to be distinguished, which may enable saturation determinations. Moreover, evaluating the position of the oil signal on the map, may enable the viscosity of the oil to be estimated from various correlations to logarithmic mean relaxation times.

As described above, NMR measurements involve the application of a static B₀ magnetic field to the magnetic moments (spins) of atoms in the measured object (or measured volume). In general, the B₀ field causes the atoms in the interrogated volume to align along and oscillate (precess) about the axis of the applied magnetic field. NMR measures the return to the equilibrium of this static magnetization (i.e., relaxation) after applying a series of RF pulses to tip the magnetization in a direction orthogonal to the static magnetic field. Longitudinal relaxation due to energy exchange between the spins of the atoms and the surrounding lattice (spin-lattice relaxation) is usually denoted by a time constant T1 when the longitudinal magnetization has returned to a predetermined percentage (i.e., 63% or 1−1/e) of its final value. Longitudinal relaxation involves the component of the spin parallel or anti-parallel to the direction of the magnetic field. Transverse relaxation that results from spins getting out of phase is usually denoted by time constant T2 when the transverse magnetization has lost a predetermined percentage (i.e., 37% or 1/e) of its original value.

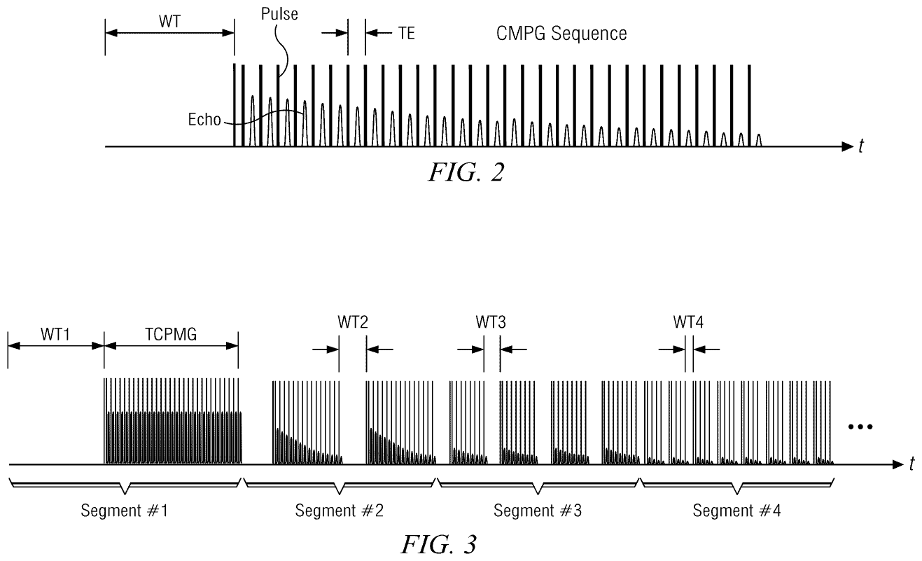

NMR measurements may be acquired using particular data acquisition schemes (commonly referred to as pulses or pulse sequences) which describe the sequence of transmission and reception of electromagnetic RF signals. A Carr-Purcell-Meiboom-Gill (CPMG) pulse sequence is commonly used to make downhole NMR measurements (e.g., to acquire the T2 relaxation time distribution). As depicted in FIG. 2, a CPMG pulse sequence (also referred to herein as an echo train) includes an initial idle time or wait time WT to allow the nuclei in the formation fluids to equilibrate with the static B₀ field. Thereafter, a series of RF pulses are applied using an antenna. At some time between adjacent RF pulses, NMR signals called echoes are formed and measured using the antenna (with the number of RF pulses and the corresponding acquired echoes being represented by N_{ECHO} or NE). The time spacing between adjacent refocusing RF pulses is referred to as T_{ECHO} or TE. The time spacing between the excitation pulse and the first refocusing pulse may commonly be set to T_{ECHO}/2 The amplitudes of the echoes decays or attenuates with time. By fitting the decaying echo amplitudes to a multi-exponential model, a T2 distribution may be obtained.

FIG. 3 depicts a common pulse sequence for measuring a T1-T2 map (or T1 and T2 distributions). The depicted sequence includes of a series of CPMG segments or subsequences (segment #s 1, 2, 3, and 4 in this example) with different wait times WT1, WT2, WT3, and WT4, different number of RF pulses N_{ECHO}, and different time spacing between adjacent pulses T_{ECHO} to make measurements over a range of properties (as is commonly found in subterranean formations). For example, segment #1 having a long wait time WT1 may have sensitivity to longer T1 and T2 components but is often executed only once owing to the inherently longer measurement time. Segment #s 3 and 4, having short wait times WT3 and WT4, are often executed multiple times to ensure enough sensitivity to the shorter T1 and T2 components. In addition, the short segments often use a short T_{ECHO} to capture short T2 components that decay quickly. It will, of course, be appreciated that the disclosed embodiments are not limited to any particular number of segments.

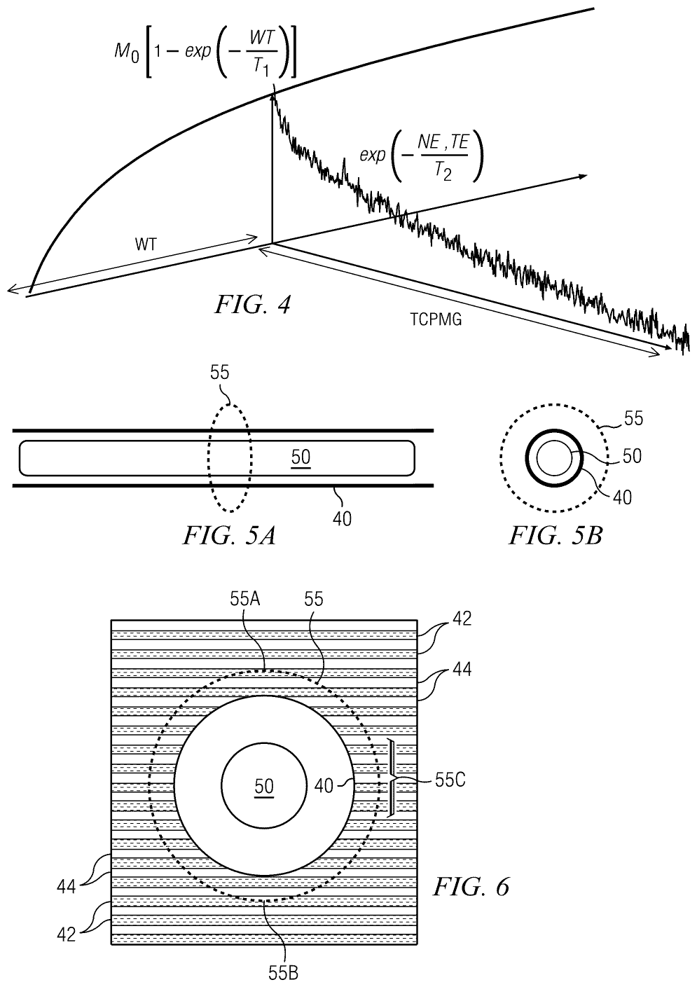

FIG. 4 depicts a diagram (or a plot) of an NMR signal obtained using a pulse sequence such as that depicted on FIG. 3. NMR measurements that make use of multiple CPMG pulse sequences may be characterized or modeled, for example, by following equation:

$$F [ f ] ( {τ}_{1} , {τ}_{2} ) = \int f ( {T}_{1} , {T}_{2} ) ( 1 - c exp ( - \frac{{τ}_{1}}{{T}_{1}} ) ) exp ( - \frac{{τ}_{2}}{{T}_{2}} ) {dT}_{1} d {T}_{2} \qquad ( 1 )$$

where f(T₁, T₂) represents the T1-T2 distribution of interest and c∈[1,2] is a model parameter reflecting the quality of the experiment. In Eq. (1) τ₁ represents the longitudinal recovery time and is equivalent to the wait time WT described above, and τ₂ represents the transverse decay time and is equivalent to the product of the number of RF pulses N_{ECHO} (NE) and the time spacing between adjacent pulses T_{ECHO} (TE).

Turning now to FIG. 5A, one example embodiment of NMR tool 50 is shown deployed in the horizontal section (or a near horizontal section) of wellbore 40. In the example depiction, NMR tool 50 is approximately centered in the wellbore 40, although it will be appreciated that the disclosed embodiments are not limited in this regard. FIG. 5B further schematically depicts a sensitive region 55 of the NMR tool 50 (the thin region from which the measured NMR response emanates during an NMR logging operation). In general, the sensitive region 55 of an NMR tool is a thin-walled cylinder (e.g. having an axial length of several centimeters and a radial thickness of around 1 centimeter. For example, the sensitive region of the slim LWD NMR tool (available from SLB) has an axial length of about 6 cm and a radial thickness of about 1 cm (with the diameter of the cylindrical sensitive region being about 25 cm). It will be appreciated that the effective vertical resolution of an NMR tool, as seen on a common log, may also be impacted by the logging speed, the signal to noise ratio, and stacking of adjacent measurements and may therefore extend further than the intrinsic response based on the tools' sensitive region.

FIG. 6 schematically depicts an axial cross section of an example deployment of NMR tool 50 in a formation having alternating thin beds 42 and 44. The thin beds may have different formation properties, such as different formation porosity values. One aspect of the disclosed embodiments, was the realization that thin beds or layers at the top 55A or bottom 55B of the sensitive region intersect a larger proportion of the sensitive region and may therefore contribute more signal to the overall measurement and that the beds or layers at the center 55C of the sensitive region (e.g., proximate to the tool axis) intersect a smaller proportion of the sensitive region and may therefore contribute less signal to the overall measurement (or response). As such, it was theorized herein that the radial response function of an NMR tool is not constant (or uniform), but is rather a maximum proximate to the upper and lower ends of the sensitive region and minimum proximate to the center or tool axis. It was still further realized that evaluating NMR data in combination with an appropriate non-constant radial response function may provide improved interpretation of thin bed formation models.

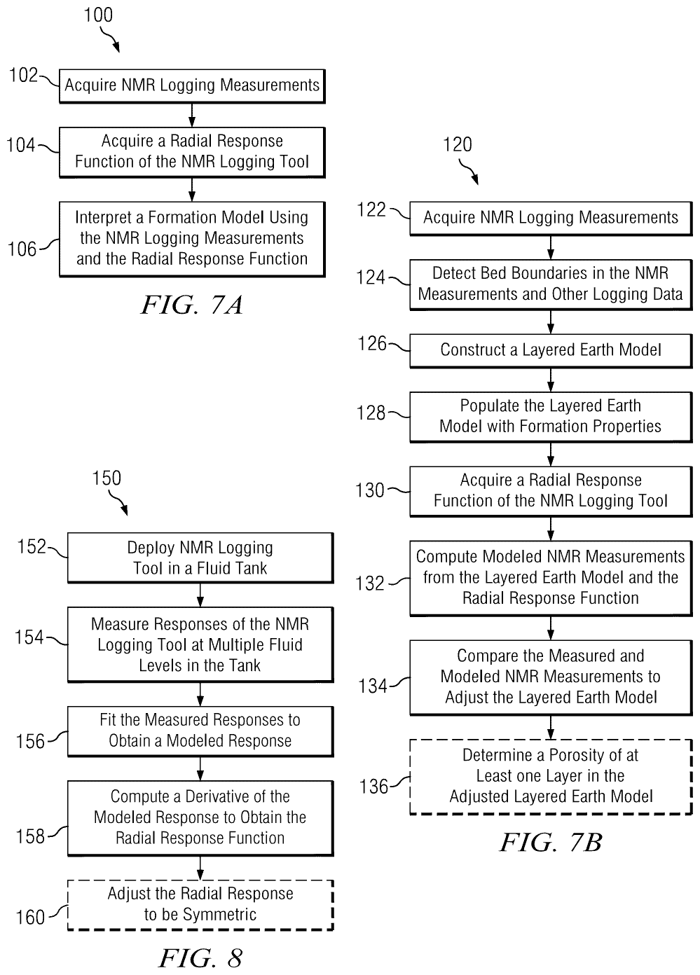

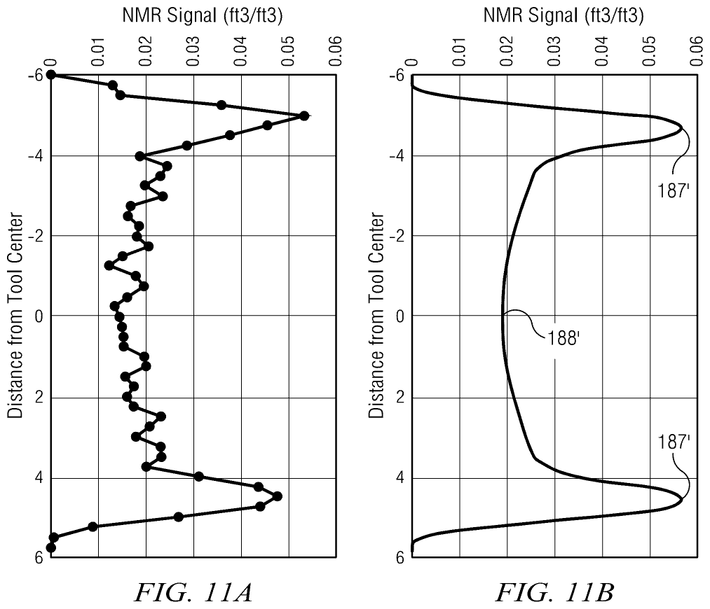

FIGS. 7A and 7B (collectively FIG. 7) depict flow charts of example methods 100 and 120 of interpreting NMR measurements. In FIG. 7A, NMR logging measurements (e.g., LWD NMR measurements) are acquired at 102. The NMR logging measurements may be acquired via making NMR logging measurements, for example, as described above with respect to FIGS. 1-4. Moreover, the NMR logging measurements may be advantageously acquired in a horizontal or near horizontal wellbore (e.g., at an inclination in a range from 80 degrees to 100 degrees or in a range from 85 degrees to 95 degrees). A radial response function of the NMR logging tool may be acquired at 104. The radial response function is generally non-constant and may be measured, for example, as described in more detail below with respect to FIGS. 8-10. The NMR logging measurements may be evaluated at 106 in combination with the acquired, non-constant radial response function to interpret a subterranean formation model including at least two layers (e.g., a multilayer thin bed model such as depicted in FIG. 6 or in FIG. 11).

In FIG. 7B, NMR porosity measurements may be acquired in a horizontal or near horizontal wellbore in a thinly bedded reservoir (formation) at 122. By thinly bedded it is meant that the formation includes at least one layer or bed having a thickness less than about twice the wellbore diameter. The NMR data may be evaluated at 124 in combination with other logging data (e.g., nuclear or resistivity logs) to detect bed boundaries. A representative layered earth model may be constructed around the well trajectory at 126, for example, using a petrophysical software package such as 3DP (3D Petrophysics) available from SLB. LWD images and dip data may be used to adjust the dipping of the formation layers (beds). The constructed layered earth model may be populated with various formation properties (including porosity) from the logging data at 128.

With continued reference to FIG. 7B, a radial response function of the NMR logging tool may be acquired at 130. The radial response function is generally non-constant and may be measured, for example, as described in more detail below. A forward model may be run at 132 to obtain modeled NMR measurements. The forward model is based on the layered earth model constructed and populated at 126 and 128 and makes use of the acquired radial response function of the NMR tool. The NMR measurements acquired at 122 and the modeled NMR measurements obtained at 132 may be compared at 134. The layered earth model constructed at 126 may be adjusted based on the comparison, for example, to achieve the best match or fit between the NMR measurements and the modeled NMR measurements at 134 (within a predetermined tolerance). An NMR derived porosity of one or more layers in the adjusted layered earth model may optionally be determined at 136. Moreover, volumes of selected layers may be optionally computed for reservoir characterization.

Turning now to FIG. 8, a flow chart of one disclosed method 150 for estimating a radial response function of an NMR logging tool is depicted. The NMR logging tool is deployed horizontally in a fluid tank at 152. The fluid tank may be configured to fully or partially immerse the NMR logging tool in a fluid such as a water-based fluid (e.g., pure water) or an oil-based fluid. It will be appreciated that the disclosed embodiments do not necessarily require a radial response function to be determined for each and every NMR logging tool. In some implementations a distinct radial response function may be determined for each individual NMR logging tool (e.g., analogous to a tool calibration). In other implementations the radial response function may be determined for a particular kind or class (such as a particular model number) of NMR logging tools. In such implementations, the radial response function may be determined for a first tool and then used with a second, similar tool.

With continued reference to FIG. 8, NMR logging measurements may be made while the NMR logging tool is deployed in the fluid tank at 154. The NMR logging measurements may be made at multiple incremental fluid levels within the sensitive region of the NMR logging tool at 154 to obtain the NMR response as a function of the fluid level within the sensitive region. The NMR logging measurements may advantageously be made at 10 or more distinct incremental fluid levels within the sensitive region (e.g., 20 or more, 25 or more, or 30 or more). For example, the NMR measurements may be made at 0.5 cm increments in the fluid (e.g., water) level. In an example NMR logging tool having a sensitive region with a diameter of 25 cm, a total of 50 measurements may be made in the sensitive region. A derivative of the NMR responses obtained at 154 may be computed at 158 to obtain the radial response function of the NMR logging tool. For example, the NMR response measurements may be fit with a function such as a polynomial function at 156. A derivative of the fitting function may then be computed at 158 to obtain the radial response function. The obtained radial response function may optionally be further adjusted or modified at 160 to ensure symmetry about the axis of the NMR logging tool (i.e., to obtain a radial response function that is symmetric about the tool axis). The obtained radial response function may also optionally be further adjusted to smooth the function.

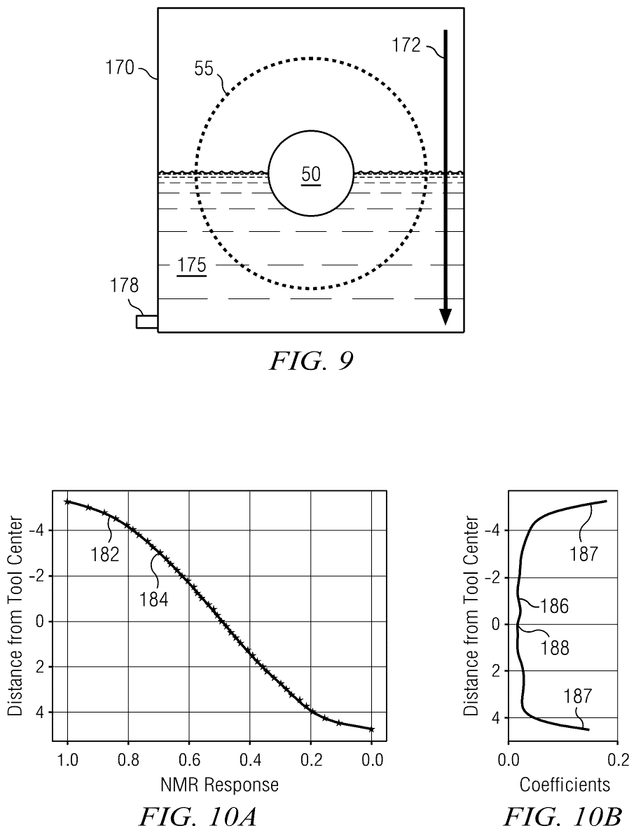

With still further reference to FIG. 8, and further reference to FIG. 9, an example radial response function was measured for a Slim LWD NMR tool (available from SLB). The NMR tool 50 was deployed in the tank 170 and the tank was filled with water 175 via a fluid port 178. A total of 51 NMR measurements were made and analyzed at corresponding distinct water levels in the tank. The water level was graded into 51 evenly spaced levels (increments) with a 0.25 inch spacing (covering a vertical distance of 12.5 inches). A water pump (not shown) was used to drop the water level in the tank between measurements (as shown at 172). The first measurement was made above the tool's sensitive region and the last (51st) measurement was made below the tool's sensitive region. The measured NMR response was observed to decrease rapidly between water levels at the top and bottom of the sensitive region. The vertical distance between the top and the bottom of the measured response function was very close to 10 inches (25 cm), which is consistent with the diameter of investigation of evaluated NMR tool.

FIGS. 10A and 10B depict plots of the measured NMR response and a corresponding polynomial fit (10A) and the contribution coefficients computed from the derivative of the NMR polynomial fit (10B) on the horizontal axis versus the radial distance from the tool center on the vertical axis. In FIG. 10A, the individual measurements are shown at 184 and the polynomial fit is shown at 182. Note that the NMR response is a maximum (having a value of 1) when the tank is full (above the sensitive region) and a minimum (having a value of 0) when the tank is empty (below the sensitive region). An excellent fit 182 of the NMR response measurements was achieved using a polynomial fitting function. In this example, the polynomial fit was given as follows: R=−4.197e−07D⁹+2.072e−05D⁸−0.0004382D⁷+0.005204D⁶−0.03819D⁵+0.1798D⁴−0.545D³+1.039D²−1.237D+1.526, where R represents the NMR response and D represents the distance from the tool center in units of inches.

FIG. 10B plots the contribution coefficients computed from the derivative of the NMR response through multiplying by the water level increment (10B) on the horizontal axis versus the radial distance from the tool center on the vertical axis. In particular, the contribution coefficients 186 computed from the derivative of the polynomial fit 182 is plotted. Note that the contribution coefficients have maxima 187 at the upper and lower ends of the sensitive region and a minimum 188 at the tool center. In this particular example, the first derivative is given by the following polynomial: R′=−3.778e−06D⁸+0.0001657D⁷−0.003067D⁶+0.03122D⁵−0.191D⁴+0.7192D³−1.635D²+2.078D−1.237. The contribution coefficients computed from the first derivative 186 of the measured NMR response 184 or of the fit 182 may be taken to be the radial response function of the NMR logging tool (or an estimate thereof).

With continued reference to FIG. 10, it will be appreciated that the determination of the response function does not require fitting the measured NMR response. For example, a discrete derivative may be computed (increment by increment or distance by distance from the tool center) by computing the differences between adjacent measurements and dividing the computed differences by the water level increment (0.25 inches in this example). The derivative may then optionally be fit (e.g., to a polynomial function) to obtain an analytical response function. In alternative embodiments, a discrete response function may be employed. The disclosed embodiments are not limited in these regards.

With continued reference to FIGS. 9 and 10, and further reference to FIGS. 11A and 11B (collectively FIG. 11) computed coefficients from the discrete derivative (11A) of the measured NMR responses and a continuous response function (11B) for the Slim NMR LWD tool are depicted. In FIG. 11A, the distance between the locations of the maxima was 9.25 inches, with each peak being about one inch wide. The contribution coefficients computed from the derivative were noisy near the tool axis where the difference in signal level between successive water levels was small. As described previously, the depicted discrete response function shows higher contribution from the levels closer to the top and bottom of the detection region.

In FIG. 11B, the data of FIG. 11A was fit. The data from the lower peak was flipped and used in the upper peak to obtain a symmetric response function. Moreover, the scale was adjusted so that the area under the curve summed to 1.0. Note that the response function is non-constant and includes upper and lower peaks (maxima) 187′ and a central minimum 188′. The minimum 188′ is located proximate to (e.g., at) the tool axis while the maxima 187′ are located proximate to (e.g., at or near) the upper and lower ends of the sensitive region.

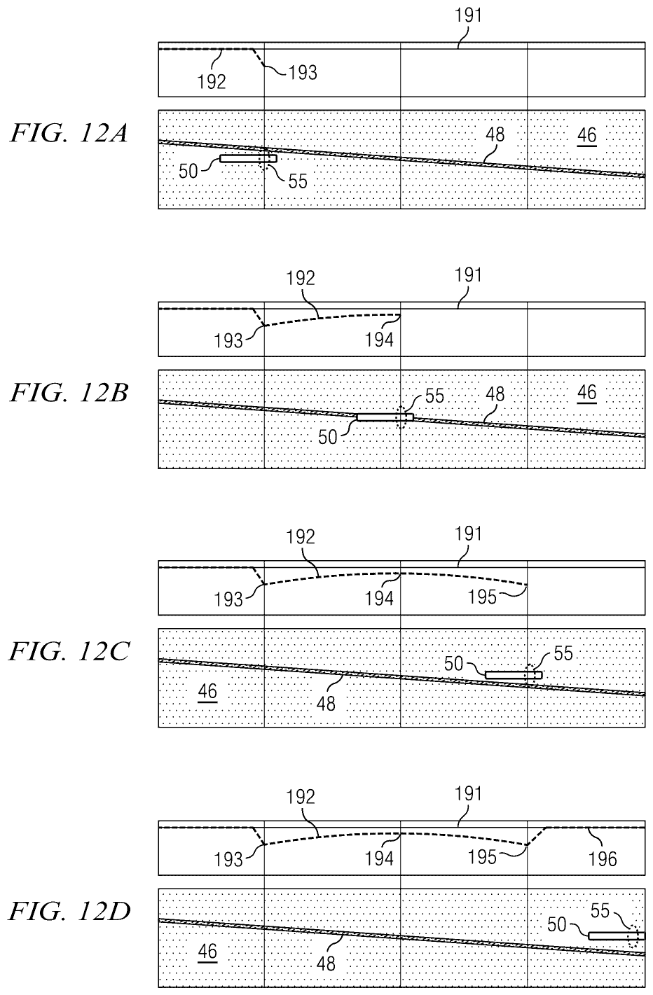

FIGS. 12A, 12B, 12C, and 12D (collectively FIG. 12) depict an example interpretation in which an NMR logging tool 50 crosses a dipping thin bed such that the thin bed changes position with respect to the sensitive region 55 from top to bottom. In this example, thin bed 48 has a dip angle of 4 degrees with respect to the NMR logging tool 50, a thickness of 1 cm, and a porosity of 10 p.u. The thin bed 48 is located in a thick layer 46 having a porosity of 20 p.u. In FIG. 12A, the NMR logging tool 50 approaches the thin dipping bed 48 from below. Prior to sensitive region 55 intercepting the thin bed 48, the NMR derived porosity 192 is equal to the porosity of the thick layer 191. As the upper end of the sensitive region 55 intercepts the thin bed 48, the NMR derived porosity drops to a minimum at 193. As drilling progresses, the NMR derived porosity 192 increases from the minimum 193 to a local maximum 194 when the NMR logging tool intercepts the thin bed (FIG. 12B). The NMR derived porosity 192 then decreases again from the local maximum 194 to a second minimum 195 when the lower end of the sensitive region intercepts the thin bed (FIG. 12C). The NMR derived porosity then increases quickly to the porosity of the thick layer 191 as shown at 196 as the NMR logging tool moves away from the thin bed with continued drilling.

With continued reference to FIG. 12, it will be appreciated that without knowledge of the NMR response function, a log analyst or petrophysicist may interpret porosity curve 192 as being obtained from a well having crossed three layers. Interpreting the NMR data and the formation model with the NMR response function enables the analyst to advantageously recognize that the NMR tool crossed only a single layer.

It will be understood that the present disclosure includes numerous embodiments. These embodiments include, but are not limited to, the following embodiments.

In a first embodiment, a method for interpreting nuclear magnetic resonance (NMR) logging measurements comprises acquiring NMR logging measurements, the NMR logging measurements made with an NMR logging tool in a horizontal or near horizontal wellbore; acquiring a radial response function for the NMR logging tool; and evaluating the acquired NMR logging measurements in combination with the acquired radial response function to interpret a subterranean formation model including at least two layers.

A second embodiment may include the first embodiment, wherein the horizontal or near horizontal wellbore has a wellbore inclination in a range from 85 degrees to 95 degrees.

A third embodiment may include any one of the first through second embodiments, wherein the radial response function is non-constant.

A fourth embodiment may include any one of the first through third embodiments, wherein the radial response function comprises a minimum that is located proximate to a central axis of the NMR logging tool and first and second maxima that are located proximate to upper and lower ends of a sensitive region of the NMR logging tool.

A fifth embodiment may include any one of the first through fourth embodiments, wherein the radial response function is symmetric about a central axis of the NMR logging tool.

A sixth embodiment may include any one of the first through fifth embodiments, wherein the acquiring the radial response function further comprises deploying the NMR logging tool in a fluid tank; making NMR measurements at a plurality of fluid levels in the fluid tank to obtain corresponding NMR responses; and computing contribution coefficients from a first derivative of the NMR responses with respect to a distance from a central axis of the NMR logging tool to obtain the radial response function.

A seventh embodiment may include the sixth embodiment, wherein the acquiring the radial response function further comprises adjusting the radial response function to be symmetric about the axis of the NMR logging tool.

An eighth embodiment may include any one of the first through seventh embodiments, wherein the evaluating the acquired NMR logging measurements further comprises computing modeled NMR measurements using a forward model based on the subterranean formation model and the acquired radial response function of the NMR logging tool; comparing the modeled NMR measurements and the acquired NMR logging measurements; and adjusting the subterranean formation model so that the modeled NMR measurements equal the acquired NMR measurements within a predetermined tolerance.

A ninth embodiment may include the eighth embodiment, further comprising computing a porosity of at least one of the at least two layers in the adjusted subterranean formation model.

A tenth embodiment may include any one of the first through ninth embodiments, wherein the subterranean formation model comprises a layered earth model constructed around a trajectory of the wellbore populated with physical properties obtained from logging measurements made in the wellbore.

In an eleventh embodiment, a method for estimating a radial response function of a nuclear magnetic resonance (NMR) logging tool comprises deploying an NMR logging tool horizontally in a fluid tank; using the NMR logging tool to make NMR measurements at each of a plurality of fluid levels in the fluid tank to obtain corresponding NMR responses; and computing contribution coefficients from a first derivative of the NMR responses with respect to a distance from an axis of the NMR logging tool to obtain the radial response function.

A twelfth embodiment may include the eleventh embodiment, wherein the fluid is water; and the NMR logging tool makes at least 25 NMR measurements at corresponding discrete water levels, wherein a first of the NMR measurements is made at a water level above a sensitive region of the NMR logging tool and a second of the NMR measurements is made at a water level below the sensitive region of the NMR logging tool.

A thirteenth embodiment may include any one of the eleventh through twelfth embodiments, wherein the computing the contribution coefficients further comprises fitting the NMR responses with a fitting function; and computing the contributions coefficients from the first derivative of the fitting function to obtain the radial response function.

A fourteenth embodiment may include any one of the eleventh through twelfth embodiments, wherein the computing the contribution coefficients further comprises computing the contribution coefficients from a discrete derivative of the NMR responses; and fitting the contribution coefficients with a fitting function to obtain the radial response function.

A fifteenth embodiment may include any one of the eleventh through fourteenth embodiments, further comprising adjusting the radial response function to be symmetric about the axis of the NMR logging tool.

A sixteenth embodiment may include any one of the eleventh through fifteenth embodiments, wherein the deploying the NMR logging tool and using the NMR logging tool to make NMR measurements, further comprise deploying the NMR logging tool horizontally in the fluid tank; filling the fluid tank with the fluid, wherein the fluid is water; making a first NMR logging measurement at a first fluid level above a sensitive region of the NMR logging tool; lowing the fluid level a predetermined depth increment and making another NMR logging measurement; repeating the lowering and the making at least 25 times at fluid levels with the sensitive region of the NMR logging tool; and making a final NMR logging measurement at a final fluid level below the sensitive region of the NMR logging tool.

In a seventeenth embodiment, a system for interpreting nuclear magnetic resonance (NMR) logging measurements comprises an NMR logging tool configured to make NMR logging measurements in a horizontal or near horizontal subterranean wellbore; and a processor configured to: receive the NMR logging measurements; acquire a radial response function of the NMR logging tool; and evaluate the received NMR logging measurements in combination with the acquired radial response function to interpret a subterranean formation model including at least two layers.

An eighteenth embodiment may include the seventeenth embodiment, wherein the radial response function is symmetric about a central axis of the NMR logging tool and comprises a minimum that is located proximate to a central axis of the NMR logging tool and first and second maxima that are located proximate to upper and lower ends of a sensitive region of the NMR logging tool.

A nineteenth embodiment may include any one of the seventeenth through eighteenth embodiments, wherein the evaluate the acquired NMR logging measurements further comprises compute modeled NMR measurements using a forward model based on the subterranean formation model and the acquired radial response function of the NMR logging tool; compare the modeled NMR measurements and the acquired NMR logging measurements; and adjust the subterranean formation model so that the modeled NMR measurements equal the acquired NMR measurements within a predetermined tolerance.

A twentieth embodiment may include any one of the seventeenth through nineteenth embodiments, wherein the processor is further configured to compute contribution coefficients of a first derivative of NMR measurements made at multiple fluid levels in a fluid tank with respect to a distance from a central axis of the NMR logging tool to obtain the radial response function.

Although NMR interpretation using a radial response function has been described in detail, it should be understood that various changes, substitutions and alternations can be made herein without departing from the spirit and scope of the disclosure as defined by the appended claims.

What is claimed is:

1. A method for interpreting nuclear magnetic resonance (NMR) logging measurements, the method comprising:
acquiring NMR logging measurements, the NMR logging measurements made with an NMR logging tool in a horizontal or near horizontal wellbore;
acquiring a radial response function for the NMR logging tool; and
evaluating the acquired NMR logging measurements in combination with the acquired radial response function to interpret a subterranean formation model including at least two layers.

2. The method of claim 1, wherein the horizontal or near horizontal wellbore has a wellbore inclination in a range from 85 degrees to 95 degrees.

3. The method of claim 1, wherein the radial response function is non-constant.

4. The method of claim 1, wherein the radial response function comprises a minimum that is located proximate to a central axis of the NMR logging tool and first and second maxima that are located proximate to upper and lower ends of a sensitive region of the NMR logging tool.

5. The method of claim 1, wherein the radial response function is symmetric about a central axis of the NMR logging tool.

6. The method of claim 1, wherein the acquiring the radial response function further comprises:
deploying the NMR logging tool in a fluid tank;
making NMR measurements at a plurality of fluid levels in the fluid tank to obtain corresponding NMR responses; and
computing contribution coefficients from a first derivative of the NMR responses with respect to a distance from a central axis of the NMR logging tool to obtain the radial response function.

7. The method of claim 6, wherein the acquiring the radial response function further comprises adjusting the radial response function to be symmetric about the axis of the NMR logging tool.

8. The method of claim 1, wherein the evaluating the acquired NMR logging measurements further comprises:
computing modeled NMR measurements using a forward model based on the subterranean formation model and the acquired radial response function of the NMR logging tool;
comparing the modeled NMR measurements and the acquired NMR logging measurements; and
adjusting the subterranean formation model so that the modeled NMR measurements equal the acquired NMR measurements within a predetermined tolerance.

9. The method of claim 8, further comprising computing a porosity of at least one of the at least two layers in the adjusted subterranean formation model.

10. The method of claim 1, wherein the subterranean formation model comprises a layered earth model constructed around a trajectory of the wellbore populated with physical properties obtained from logging measurements made in the wellbore.

11. A method for estimating a radial response function of a nuclear magnetic resonance (NMR) logging tool, the method comprising:
deploying an NMR logging tool horizontally in a fluid tank;
using the NMR logging tool to make NMR measurements at each of a plurality of fluid levels in the fluid tank to obtain corresponding NMR responses; and
computing contribution coefficients from a first derivative of the NMR responses with respect to a distance from an axis of the NMR logging tool to obtain the radial response function.

12. The method of claim 11, wherein:
the fluid is water; and
the NMR logging tool makes at least 25 NMR measurements at corresponding discrete water levels, wherein a first of the NMR measurements is made at a water level above a sensitive region of the NMR logging tool and a second of the NMR measurements is made at a water level below the sensitive region of the NMR logging tool.

13. The method of claim 11, wherein the computing the contribution coefficients further comprises:
fitting the NMR responses with a fitting function; and
computing the contributions coefficients from the first derivative of the fitting function to obtain the radial response function.

14. The method of claim 11, wherein the computing the contribution coefficients further comprises:
computing the contribution coefficients from a discrete derivative of the NMR responses; and
fitting the contribution coefficients with a fitting function to obtain the radial response function.

15. The method of claim 11, further comprising adjusting the radial response function to be symmetric about the axis of the NMR logging tool.

16. The method of claim 11, wherein the deploying the NMR logging tool and using the NMR logging tool to make NMR measurements, further comprise:
deploying the NMR logging tool horizontally in the fluid tank;
filling the fluid tank with the fluid, wherein the fluid is water;
making a first NMR logging measurement at a first fluid level above a sensitive region of the NMR logging tool;
lowing the fluid level a predetermined depth increment and making another NMR logging measurement;
repeating the lowering and the making at least 25 times at fluid levels with the sensitive region of the NMR logging tool; and
making a final NMR logging measurement at a final fluid level below the sensitive region of the NMR logging tool.

17. A system for interpreting nuclear magnetic resonance (NMR) logging measurements, the system comprising:
an NMR logging tool configured to make NMR logging measurements in a horizontal or near horizontal subterranean wellbore; and
a processor configured to:
receive the NMR logging measurements;
acquire a radial response function of the NMR logging tool; and
evaluate the received NMR logging measurements in combination with the acquired radial response function to interpret a subterranean formation model including at least two layers.

18. The system of claim 17, wherein the radial response function is symmetric about a central axis of the NMR logging tool and comprises a minimum that is located proximate to a central axis of the NMR logging tool and first and second maxima that are located proximate to upper and lower ends of a sensitive region of the NMR logging tool.

19. The system of claim 17, wherein the evaluate the acquired NMR logging measurements further comprises:
compute modeled NMR measurements using a forward model based on the subterranean formation model and the acquired radial response function of the NMR logging tool;
compare the modeled NMR measurements and the acquired NMR logging measurements; and
adjust the subterranean formation model so that the modeled NMR measurements equal the acquired NMR measurements within a predetermined tolerance.

20. The system of claim 17, wherein the processor is further configured to compute contribution coefficients of a first derivative of NMR measurements made at multiple fluid levels in a fluid tank with respect to a distance from a central axis of the NMR logging tool to obtain the radial response function.
